(19) United States
(12) Patent Application Publication
(10) Pub. No.: US 2010/0003430 A1
(43) Pub. Date: Jan. 7, 2010

(54) SECTIONAL HOLLOW STRUCTURE AND TEMPLATE THEREOF

(76) Inventor: Jung-Ya HSIEH, Taichung City (TW)

Correspondence Address: SINORICA, LLC, 2275 Research Blvd., Suite 500, ROCKVILLE, MD, 20850, US

(21) Appl. No.: 12/165,693

(22) Filed: Jul. 1, 2008

(51) Int. Cl. B32B 3/02; B29D 22/00

(52) U.S. Cl. 428/34.1; 428/80

(57) ABSTRACT

A sectional hollow structure includes a plurality of hexagonal templates, pentagonal templates and fastening parts to assemble a Buckminster-ball-like hollow structure. Five hexagonal templates adjoin a pentagonal template via five sides of the pentagonal template. A hexagonal template adjoins three hexagonal templates and three pentagonal templates alternately via six sides of the hexagonal template.

### BACKGROUND OF THE INVENTION

1. Field of the Invention

The present invention relates to a sectional hollow structure and templates thereof, and more particularly, to a Buckminster-ball-like hollow structure after assembly.

2. Description of the Prior Art

The prior art of a variety of sectional structures of buildings, walls, and houses is disclosed in U.S. Pat. No. 3,590,448, U.S. Pat. No. 3,744,191, U.S. Pat. No. 3,885,360, U.S. Pat. No. 3,996,320, U.S. Pat. No. 4,245,809, U.S. Pat. No. 4,442,059, U.S. Pat. No. 5,732,518, and U.S. Pat. No. 6,840,013. The prior as disclosed in the aforesaid patents teaches the use of hollow spherical or arc-shaped structures and arc-shaped templates to meet the requirements of architectural design.

The prior art is directed to various improved sectional structures or materials for constructing buildings, walls, and houses. However, such sectional structures or materials are already well known to the general public. Hence, there is still room for improvement as far as the sectional structures or materials are concerned.

According, a problem that calls for immediate solution involves providing a sectional hollow structure for use with sectional buildings or sectional containers so as to facilitate installation and uninstallation thereof, enhance structural strength thereof, and attain diverse sectional applications thereof in daily life.

### SUMMARY OF THE INVENTION

To solve the problem with the prior art, the present invention provides a sectional hollow structure comprising a plurality of hexagonal templates, pentagonal templates, and fastening parts for connecting the hexagonal templates and the pentagonal templates. Five corresponding ones of the hexagonal templates adjoin a corresponding one of the pentagonal templates via five sides of the corresponding one of the pentagonal templates. Each of the hexagonal templates adjoins three corresponding ones of the hexagonal templates and three corresponding ones of the pentagonal templates alternately via six sides of the hexagonal template. As a result, a Buckminster-ball-like hollow structure is formed.

Accordingly, it is a primary objective of the present invention to provide a sectional hollow structure for use with sectional buildings or sectional containers.

Another objective of the present invention is to provide a sectional hollow structure which is easy to install and uninstall.

Yet another objective of the present invention is to provide a sectional hollow structure of enhanced structural strength.

A further objective of the present invention is to provide a template for use with a sectional hollow structure, so as to construct a sectional building or a sectional container.

A further objective of the present invention is to provide a template for use with a sectional hollow structure such that the sectional hollow structure is easy to install and uninstall.

A further objective of the present invention is to provide a template for use with a sectional hollow structure so as to enhance structural strength of the sectional hollow structure after assembly.

### BRIEF DESCRIPTION OF THE DRAWINGS

FIG. 1 is a schematic view of a sectional hollow structure according to a first preferred embodiment of the present invention;

FIG. 2A is a schematic view of an assembled hexagonal template according to the first preferred embodiment of the present invention;

FIG. 2B is a schematic view of an assembled pentagonal template according to the first preferred embodiment of the present invention;

FIGS. 3A to 3C are schematic views of a first template and a second template according to the present invention; and

FIGS. 4A and 4B are schematic views of fastening parts according to the present invention.

### DETAILED DESCRIPTION OF THE EMBODIMENTS

The present invention discloses a Buckminster-ball-like sectional hollow structure for use with related products. A Buckminster-ball-like hollow structure was devised by architect Richard Buckminster Fuller in the late 19^{th} century and the early 20^{th} century. The Buckminster-ball-like hollow structure, commonly known as “buckyball”, is characterized by optimal structural strength and uniform distribution of stress and therefore is used as the structure of a soccer ball and a football. Persons ordinarily skilled in the art are well aware of the structural principles of a buckyball and therefore detailed description thereof is omitted herein. Besides, the accompanying drawings are intended to illustrate the features of the present invention and therefore are not, and need not be, drawn to scale.

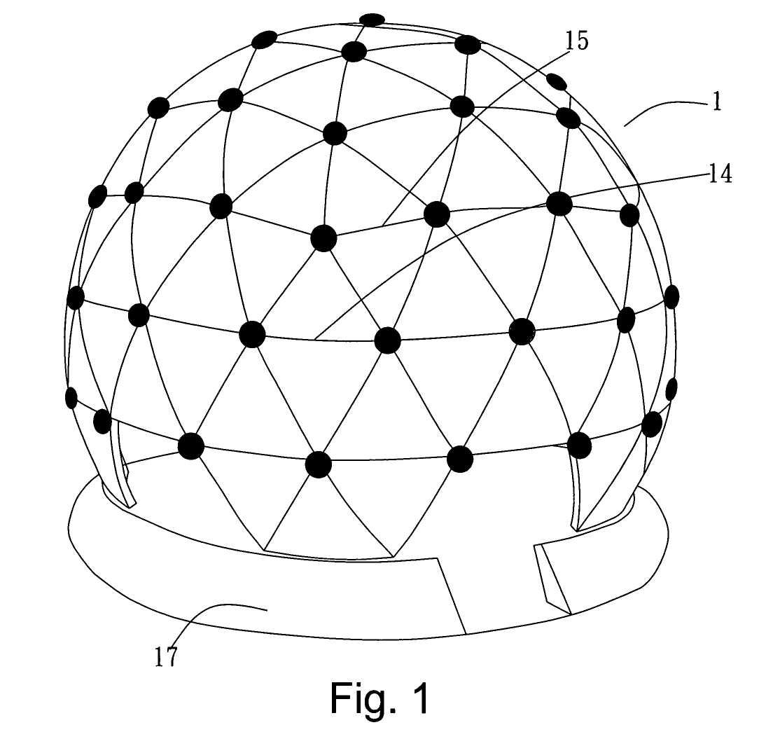

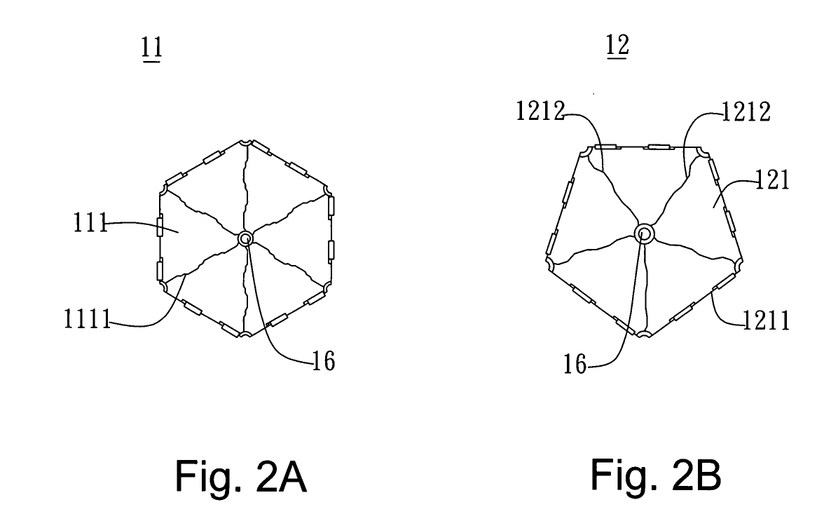

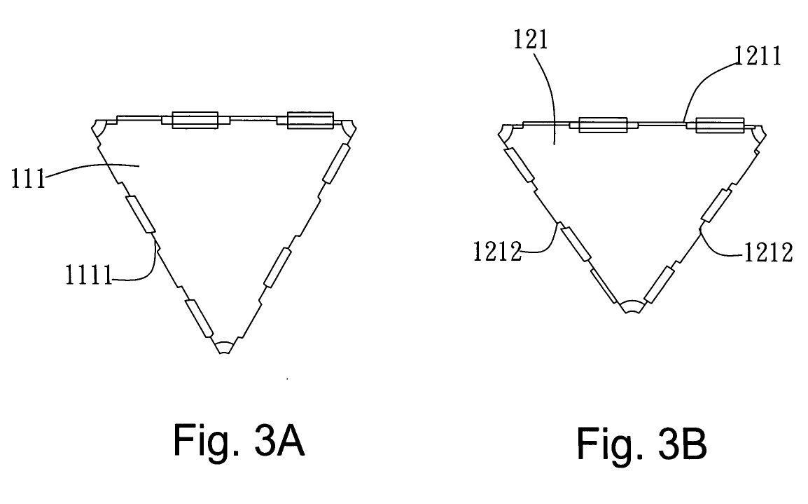

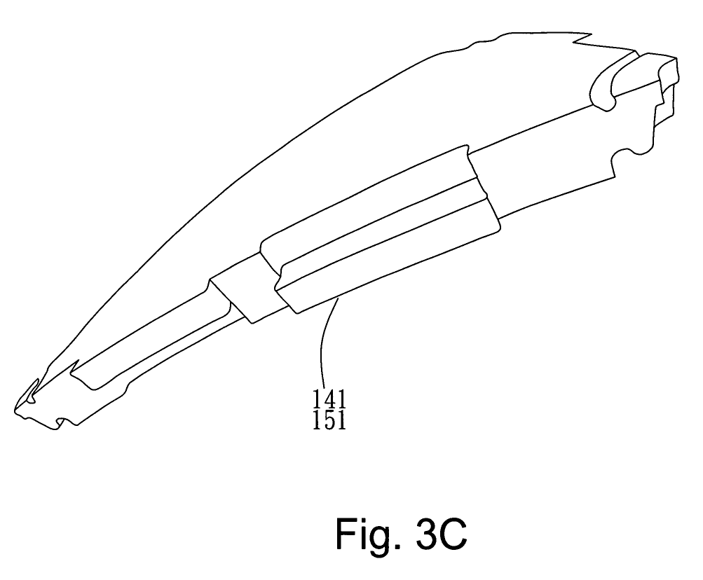

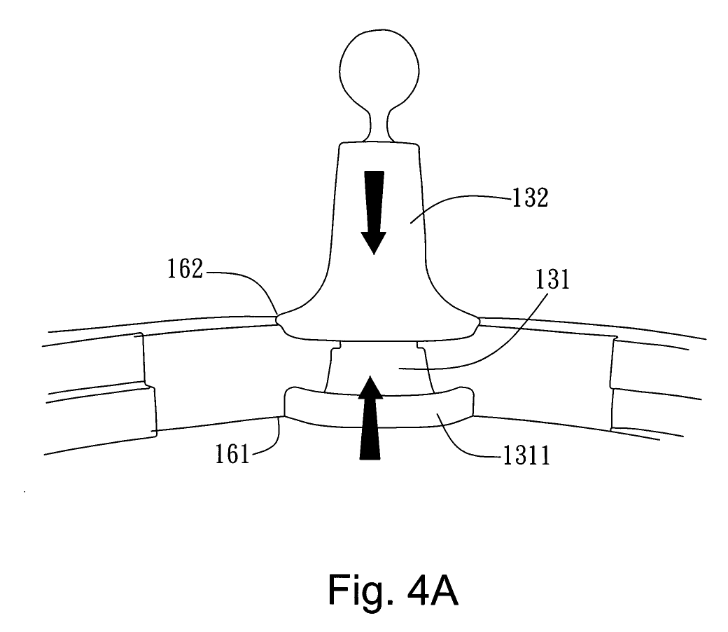

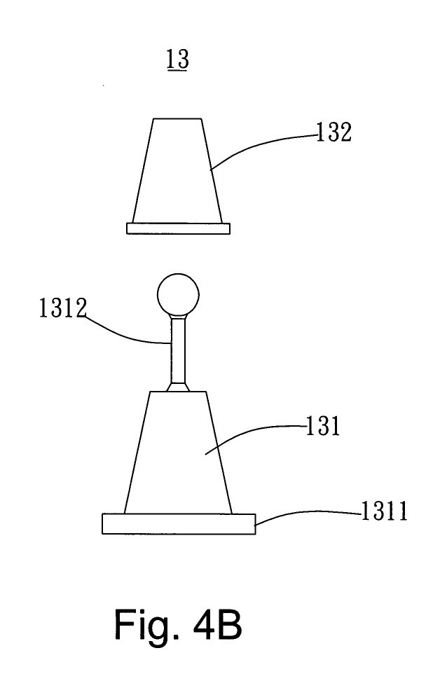

Referring to FIG. 1, FIG. 2A, FIG. 2B, FIGS. 3A to 3C, FIG. 4A, and FIG. 4B, in the first preferred embodiment proposed by the present invention, a Buckminster-ball-like sectional hollow structure 1 is provided. The sectional hollow structure 1 comprises a plurality of hexagonal templates 11, pentagonal templates 12, and fastening parts 13. Five corresponding ones of the hexagonal templates 11 adjoin a corresponding one of the pentagonal templates 12 via five sides of the corresponding one of the pentagonal templates 12, and each of the hexagonal templates 11 adjoins three corresponding ones of the hexagonal templates 11 and three corresponding ones of the pentagonal templates 12 alternately via six sides of the hexagonal templates 11, so as to form the Buckminster-ball-like sectional hollow structure 1.

Six first templates 111, each having an equilateral-triangle projection, together form a corresponding one of the hexagonal templates 11. Sides of each of the first templates 111 are of a first length 1111. Three side surfaces of each of the first templates 111 are tilted such that lines extending from the three side surfaces intersect at a spherical center. Five second templates 121, each having an isosceles-triangle projection, together form a corresponding one of the pentagonal templates 12. Each of the second templates 121 has a base side of a first length 1211 and leg sides of a second length 1212, wherein the second length 1212 is shorter than the first length 1211. Three side surfaces of each of the second templates 121 are tilted such that lines extending from the three side surfaces intersect at a spherical center.

To couple the templates to one another, a first engaging portion 14 is formed on any of the sides of each of the first template 111 and the base side of each of the second templates 121 so as to engage an adjacent one of the first templates 111 or the base side of an adjacent one of the second templates 121. A second engaging portion 15 is formed on the leg sides of each of the second templates 121 to engage a corresponding one of the leg sides of an adjacent one of the second templates 121. A plurality of arc-shaped notches 16 are formed at vertices of each of the first templates 111 and each of the second templates 121. A plurality of paired fastening parts 13 are penetratingly disposed in the arc-shaped notches 16 to screw adjacent ones of the first templates 111 and the second templates 121 together. Hence, six corresponding ones of the first templates 111 together form a corresponding one of the hexagonal templates 11, and five corresponding ones of the second templates 121 together form a corresponding one of the pentagonal templates 12.

Preferably, internal surfaces of the first templates 111 and the second templates 121 are arc-shaped, so that when the sectional hollow structure is applied to an audiovisual room, an entire internal surface of the sectional hollow structure is evenly arc-shaped for and can be used as a projection screen. If external surfaces of the templates are arc-shaped, the assembled sectional hollow structure will look spherical and have an optimal esthetic effect. If both the internal and external surfaces of the templates are arc-shaped, the assembled sectional hollow structure will have maximum structural strength. Nonetheless, ease of installation and uninstallation can be achieved by flat internal surfaces and flat external surfaces of the templates.

Referring to FIG. 3A to FIG. 3C, the first engaging portion 14 is provided with two pairs of complementarily configured first stepped structures 141, and the first stepped structures 141 are preferably longitudinally aligned along the sides of the templates so as to attain enhanced stability. However, in the presence of limitation of dimensions, in addition to being longitudinally aligned along the sides of the templates, the first engaging portion 14 can be provided with at least one pair of complementarily configured first stepped structures 141 which are transversely aligned along the sides of the templates.

The second engaging portion 15 is provided with two pairs of complementarily configured second stepped structures 151, and the second stepped structures 151 are preferably longitudinally aligned along the sides of the templates so as to attain enhanced stability. In addition to being longitudinally aligned along the sides of the templates, the second stepped structures 151 can be aligned oppositely. However, in the presence of limitation of dimensions, the second engaging portion 15 can be provided with at least one pair of complementarily configured second stepped structures 151 which are longitudinally or transversely aligned along the sides of the templates. Owing to the difference in length between the sides of the hexagonal templates and the pentagonal templates, the first stepped structures 141 differ slightly from the second stepped structures 151 in their locations on the engaging portions, though the rest of the structures remain the same.

Referring to FIG. 4A and FIG. 4B, each of the fastening parts 13 comprises a bolt 131 and a nut 132. The bolt 131 has a base 1311 and an extension portion 1312. A bottom surface of the base 1311 of the bolt 131 is either arc-shaped or flat. The extension portion 1312 is, in part or in whole, formed with an external thread for engagement with an internal thread of the nut 132. The nut 132 is preferably provided with a protruding nut cap 1321 having a closed end. To reduce manufacturing costs, the nut 132 can be made simple and plain. Where the internal surface of the sectional hollow structure 1 functions as a projection screen, the bolts 131 protrude outward from inside corresponding ones of the arc-shaped notches 16 so as to be screwed to corresponding ones of the nuts 132; meanwhile, the internal surface of the sectional hollow structure 1 is evenly arc-shaped. Where the internal surface of the sectional hollow structure 1 is for use in an audiovisual room, the bolts 131 protrude inward from outside corresponding ones of the arc-shaped notches 16 so as to be screwed to corresponding ones of the nuts 132, thus allowing the protrusion to eliminate undesired reverberation. To optimize the outcome of installation, the arc-shaped notches 16 are further provided with first dent portions 161 for receiving the bases 1311 of the bolts 131 screwed therein. The first dent portions 161 can be provided inside or outside the arc-shaped notches 16. On the other hand, the arc-shaped notches 16 are further provided with second dent portions 162 for receiving the nuts screwed therein. The second dent portions 162 are located opposite first dent portions 161. More particularly, if the first dent portions 161 lie inside the arc-shaped notches 16, the second dent portions 162 will lie outside the arc-shaped notches 16. Conversely, if the first dent portions 161 lie outside the arc-shaped notches 16, the second dent portions 162 will lie inside the arc-shaped notches 16.

If the sectional hollow structure 1 is intended to provide thermal insulation, the first templates 111 and the second templates 121 are preferably fabricated by foam molding, though the alternative is plastic injection molding. The sectional hollow structure 1 is applicable to a sectional building, a sectional house, a sectional container, or even a sectional toy. In addition to a complete sphere, the shape of the hollow structure can be one-fourth of a sphere, a half of a sphere, or three-fourths of a sphere. In order to position the hollow structure firmly on a supporting surface, such as a floor or a tabletop, the hollow structure can further comprise a base for supporting the hollow structure.

Referring to FIG. 3A and FIG. 3B, the present invention further provides a second preferred embodiment. Provided in the second preferred embodiment is a template for use with a sectional hollow structure. The template has an equilateral-triangle projection such that six such templates together form the aforementioned hexagonal template 11. A first engaging portion is formed on any of the sides of the template so as to engage an adjacent template. The features of the template in the second preferred embodiment are the same as the features of the first template 111 disclosed in the first preferred embodiment.

Referring to FIG. 3B and FIG. 3C, the present invention further provides a third preferred embodiment. Provided in the third preferred embodiment is a template for use with a sectional hollow structure. The template has an isosceles-triangle projection such that five such templates together form the aforementioned pentagonal template 12. The features of the template in the third preferred embodiment are the same as the features of the second template 121 disclosed in the first preferred embodiment.

The foregoing preferred embodiments are only illustrative of the features and functions of the present invention but not intended to restrict the scope of the present invention. Moreover, as the contents disclosed herein should be readily understood and can be implemented by a person skilled in the art, all equivalent changes or modifications which do not depart from the spirit of the present invention should be encompassed by the appended claims.

What is claimed is:

1. A sectional hollow structure, comprising a plurality of hexagonal templates, pentagonal templates, and fastening parts, wherein five corresponding ones of the hexagonal templates adjoin a corresponding one of the pentagonal templates via five sides of the corresponding one of the pentagonal templates, and each of the hexagonal templates adjoins three corresponding ones of the hexagonal templates and three corresponding ones of the pentagonal templates alternately via six sides of each said hexagonal template, so as to assemble a Buckminster-ball-like hollow structure, characterized in that:
each of the hexagonal templates comprises six first templates each having an equilateral-triangle projection, wherein each of the first templates has sides of a first length;
each of the pentagonal templates comprises five second templates each having an isosceles-triangle projection, wherein each of the second templates has a base side of a first length and leg sides of a second length, the second length being shorter than the first length;
a first engaging portion is formed on any of the sides of each of the first templates and the base side of each of the second templates so as to engage one of an adjacent one of the first templates and the base side of an adjacent one of the second templates;
a second engaging portion is formed on the leg sides of each of the second templates to engage a corresponding one of the leg sides of an adjacent one of the second templates;
a plurality of arc-shaped notches are formed at vertices of each of the first templates and the second templates; and
a plurality of paired fastening parts are penetratingly disposed in the arc-shaped notches to screw adjacent ones of the templates together.

2. The sectional hollow structure of claim 1, wherein three side surfaces of the first templates or the second templates are tilted such that lines extending from the three side surfaces intersect at a spherical center.

3. The sectional hollow structure of claim 1, wherein the first engaging portion is provided with at least one pair of complementarily configured first stepped structures, and the first stepped structures of the first engaging portion are longitudinally or transversely aligned along a corresponding one of the sides of the templates.

4. The sectional hollow structure of claim 1, wherein the second engaging portion is provided with at least one pair of complementarily configured second stepped structures, and the second stepped structures of the second engaging portion are longitudinally or transversely aligned along a corresponding one of the sides of the templates.

5. The sectional hollow structure of claim 1, wherein the second engaging portion is provided with two pairs of complementarily configured second stepped structures which are longitudinally aligned along a corresponding one of the sides of the templates.

6. The sectional hollow structure of claim 1, wherein the second engaging portion is provided with paired and oppositely disposed second stepped structures.

7. The sectional hollow structure of claim 1, wherein one of internal surfaces and external surfaces of the first templates and the second templates are arc-shaped.

8. The sectional hollow structure of claim 1, wherein one of internal surfaces and external surfaces of the first templates and the second templates are flat.

9. The sectional hollow structure of claim 1, wherein each of the fastening parts comprises a bolt and a nut, the bolt having a base and an extension portion, in which a bottom surface of the base is arc-shaped or flat, and the extension portion is, in part or in whole, formed with an external thread.

10. The sectional hollow structure of claim 9, wherein the nuts protrude out of the arc-shaped notches of the templates.

11. The sectional hollow structure of claim 10, wherein the arc-shaped notches of the first templates and the second templates are further provided with first dent portions for receiving the bases of the bolts screwed therein.

12. The sectional hollow structure of claim 10, wherein the arc-shaped notches of the first templates and the second templates are further provided with second dent portions for receiving the nuts screwed therein.

13. The sectional hollow structure of claim 9, wherein the bolts protrude outward from inside the arc-shaped notches so as to be screwed to corresponding ones of the nuts.

14. The sectional hollow structure of claim 9, wherein the bolts protrude outward from inside the arc-shaped notches so as to be screwed to corresponding ones of the nuts, and each of the nuts is provided with a nut cap having a closed end so as to protrude out of the sectional hollow structure.

15. The sectional hollow structure of claim 9, wherein the bolts protrude inward from outside the arc-shaped notches so as to be screwed to corresponding ones of the nuts.

16. The sectional hollow structure of claim 9, wherein the bolts protrude inward from outside the arc-shaped notches so as to be screwed to corresponding ones of the nuts, and each of the nuts is provided with a nut cap having a closed end so as to protrude into the sectional hollow structure.

17. The sectional hollow structure of claim 1, wherein the templates are fabricated by one of foam molding and plastic injection molding.

18. The sectional hollow structure of claim 1, wherein the hollow structure has a shape selected from the group consisting of one-fourth of a sphere, a half of a sphere, three-fourths of a sphere, and a complete sphere, and further comprises a base for supporting the hollow structure.

19. A template for use with a sectional hollow structure, the sectional hollow structure comprising a plurality of hexagonal templates and pentagonal templates, wherein five corresponding ones of the hexagonal templates adjoin a corresponding one of the pentagonal templates via five sides of the corresponding one of the pentagonal templates, and each of the hexagonal templates adjoins three corresponding ones of the hexagonal templates and three corresponding ones of the pentagonal templates alternately via six sides of each said hexagonal template, so as to assemble a Buckminster-ball-like hollow structure, the template being characterized in that:
the template has an equilateral-triangle projection such that six said templates together form a corresponding one of the hexagonal templates;
a first engaging portion is formed on any of the sides of the template so as to engage an adjacent one of the templates; and
the template has at least one vertex formed with an arc-shaped notch.

20. A template for use with a sectional hollow structure, the sectional hollow structure comprising a plurality of hexagonal templates and pentagonal templates, wherein five corresponding ones of the hexagonal templates adjoin a corresponding one of the pentagonal templates via five sides of the corresponding one of the pentagonal templates, and a corresponding one of the hexagonal templates adjoins three corresponding ones of the hexagonal templates and three corresponding ones of the pentagonal templates alternately via six sides of the corresponding one of the hexagonal templates, so as to assemble a Buckminster-ball-like hollow structure, the template being characterized in that:
the template has an isosceles-triangle projection such that five said templates together form a corresponding one of the pentagonal templates;
the template has a base side of a first length and two leg sides of a second length, the second length being shorter than the first length;
a second engaging portion is formed on each of the two leg sides of the template for engagement with an adjacent one of the templates; and
the template is formed with an arc-shaped notch at a vertex thereof opposite the base side.
